(19) United States
(12) Patent Application Publication
(10) Pub. No.: US 2026/0197493 A1
(43) Pub. Date: Jul. 9, 2026

(54) METHOD FOR GROUPING AND UPDATING CAMERA PARAMETERS FOR MPEG IMMERSIVE VIDEO

(71) Applicants: HYUNDAI MOTOR COMPANY, SEOUL (KR); KIA CORPORATION, SEOUL (KR); EWHA UNIVERSITY – INDUSTRY COLLABORATION FOUNDATION, SEOUL (KR)

(72) Inventors: Je Won Kang, Seoul (KR); Hee Jae Kim, Seongnam-si (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); EWHA UNIVERSITY – INDUSTRY COLLABORATION FOUNDATION, SEOUL (KR)

(21) Appl. No.: 18/863,822

(22) PCT Filed: Apr. 7, 2023
(86) PCT No.: PCT/KR2023/004720

§ 371 Date: Nov. 7, 2024

(30) Foreign Application Priority Data
May 9, 2022 (KR) 10-2022-0056664
Apr. 5, 2023 (KR) 10-2023-0044499

(51) Int. Cl. H04N 19/597; G06T 7/70; G06T 7/80

(52) U.S. Cl. CPC H04N 19/597; G06T 7/70; G06T 7/80; G06T 2207/30244

(57) ABSTRACT

A method is disclosed for camera parameter grouping and updating for MPEG immersive video. In the disclosed embodiments, an immersive video decoding device decodes the number of camera view points, the number of scenes, the number of time steps, and the number of sensors. The immersive video decoding device decodes, based on the number of camera view points, camera explicit parameters and camera implicit parameters of each scene, camera explicit and implicit parameters of each time step, and camera explicit and implicit parameters of each sensor. The immersive video decoding device extracts a view port by using camera parameters appropriate for each sensor.

### TECHNICAL FIELD

The present disclosure relates to a method for camera parameter grouping and updating for MPEG immersive video.

### BACKGROUND

The statements in this section merely provide background information related to the present disclosure and do not necessarily constitute prior art.

6 degrees of freedom or 6 DoF provides omnidirectional videos with unrestricted motion parallax, while 3DoF+ video provides motion parallax within a limited range centered on the head of a fixed view point. 6DoF video or 3DoF+ video can be obtained in two ways: windowed 6DoF and omnidirectional 6DoF. Here, windowed 6DoF is obtained from a multi-view camera system, which, similar to a window-like area, limits user's viewing of the current and neighboring view points to parallel movements thereof. Omnidirectional 6DoF forms 360-degree video with multi-view points to align with user's view point, providing viewing freedom in a confined space. For example, a viewer wearing a head-mounted display (TIMID) can experience a three-dimensional, omnidirectional virtual environment in a confined area.

Immersive video typically is composed of texture video, which is composed of RGB or YUV information, and depth video, which includes three-dimensional geometry information. In addition, an occupancy map may be included to represent information that is occluded in the third dimension.

The Moving Picture Experts Group (MPEG) is standardizing MPEG-I (MPEG-Immersive) as a project for coding immersive video. WG4 of Sub Committee 29 (SC 29) of Joint Technical Committee 1 (JTC1) within ISO/IEC is responsible for standardizing MPEG Immersive Video (MIV) for immersive video compression. ISO/IEC 23090 Part 12 (Coded Representation of Immersive Media—Part 12: Immersive Video) is the standard for MPEG-I video compression. The MIV standard also references ISO/IEC 23090 Part 5, which is Information Technology-Coded representation of immersive media—part 5: Visual Volumetric Video-based Coding (V3C) and Video-based Point Cloud Compression (V-PCC). The patched atlas format is standardized as a common specification with V-PCC, one of the point cloud standards, and that common specification is being established in V3C, while part 12 defines a MIV-specific specification.

In the context of immersive video decoding, a view port represents user's gazing area within the entire omnidirectional video. Relative to multi-view cameras arranged to capture space, the view port is typically represented by using camera extrinsic parameters and camera intrinsic parameters. On the other hand, in meta mobility, which extends viewer's range of movement in virtual space beyond the traditional concept of virtual space, mobile cameras can capture video at different times and places. Therefore, regarding MIVs (MPEG Immersive Videos) obtained by these mobile cameras, an efficient signaling scheme of camera extrinsic parameters and camera intrinsic parameters needs to be considered for multi-view camera parameter signaling and subsequent dynamic view port generation.

### DISCLOSURE

### Technical Problem

The present disclosure seeks to provide, in encoding and decoding immersive videos, a method of efficiently grouping and updating multi-view camera parameters for MIVs obtained at different times and locations according to an arbitrary arrangement of movable multi-view cameras.

### Technical Solution

At least one aspect of the present disclosure provides a method of decoding an immersive video, performed by an immersive video decoding device. The method includes decoding from a bitstream a number of camera view points. The method also includes decoding from the bitstream a number of scenes that represents a number of spaces occupied by different groups of multi-view point videos. The method also includes decoding, from the bitstream, camera parameters of each of the scenes based on the number of camera view points and the number of scenes. Here, the camera parameters comprise camera explicit parameters and camera implicit parameters.

Another aspect of the present disclosure provides a method of encoding an immersive video, performed by an immersive video encoding device. The method includes determining a number of camera view points. The method also includes determining a number of scenes that represents a number of spaces occupied by different groups of multi-view point videos. The method also includes determining camera parameters of each of the scenes based on the number of camera view points and the number of scenes. Here, the camera parameters comprise camera explicit parameters and camera implicit parameters.

Yet another aspect of the present disclosure provides a computer-readable recording medium storing a bitstream generated by an immersive video encoding method. The immersive video encoding method includes determining a number of camera view points. The immersive video encoding method also includes determining a number of scenes that represents a number of spaces occupied by different groups of multi-view point videos. The immersive video encoding method also includes determining camera parameters of each of the scenes based on the number of camera view points and the number of scenes. Here, the camera parameters comprise camera explicit parameters and camera implicit parameters.

### Advantageous Effects

As described above, the present disclosure provides a method of efficiently grouping and updating multi-view camera parameters for MIVs obtained at different times and locations according to an arbitrary arrangement of movable multi-view cameras. In immersive video encoding and decoding, the method enables rapid processing of rich three-dimensional spatial information without space and time constraints to deliver highly efficient, low-cost immersive media for meta mobility services.

Furthermore, the present disclosure can maximize immersion in remote exploration spaces. For example, an environment that is difficult to explore directly, such as outer space, can be remotely explored and experienced in a virtual environment without the constraints of space and time.

Further, by utilizing camera parameters grouped according to time and scene, and texture and depth information at each view point, the present disclosure can synthesize spatial information of untransmitted view points and reproduce the more natural stereoscopic video. For example, by interpolating between frames of a stereoscopic video based on temporally indexed camera parameters, the surrounding environment information in a specific scene can be reproduced in real time. Furthermore, spatial information can be reconstructed from various view points for each scene by using the camera parameter information indexed according to the scene, thus the user can have a high degree of viewing freedom from arbitrary view points and in scenes.

Furthermore, the present disclosure efficiently updates over time the camera extrinsic parameters and camera intrinsic parameters of the stereoscopic video, thus, smooth interaction between the user and the surrounding environment can be realized in an arbitrary virtual environment space. By freely moving the view point in the virtual environment and communicating with the surrounding environment in real-time, the user can experience the surrounding environment immersively.

### BRIEF DESCRIPTION OF THE DRAWINGS

FIG. 1 is a block diagram illustrative of an immersive video encoding device capable of implementing the techniques of the present disclosure.

FIG. 2 is a flowchart of the process of optimizing a view point in an immersive video encoding device.

FIG. 3 is a diagram illustrating the operation of a pruner in an immersive video encoding device.

FIG. 4 is a block diagram of an immersive video decoding device capable of implementing the techniques of the present disclosure.

FIG. 5 is a block diagram illustrating an encoding scheme in MPEG Immersive Video (MIV) mode.

FIG. 6 is a diagram illustrating the concept of group encoding.

FIG. 7 is a diagram illustrating the position and arrangement of cameras changing over time, according to at least one embodiment of the present disclosure.

FIG. 8 is a diagram illustrating the position and arrangement of cameras changing as the view point space and scene captured by the cameras change, according to at least one embodiment of the present disclosure.

FIG. 9 is a flowchart of a method performed by an immersive video encoding device for encoding camera parameters, according to at least one embodiment of the present disclosure.

FIG. 10 is a flowchart of a method performed by an immersive video decoding device for decoding camera parameters, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

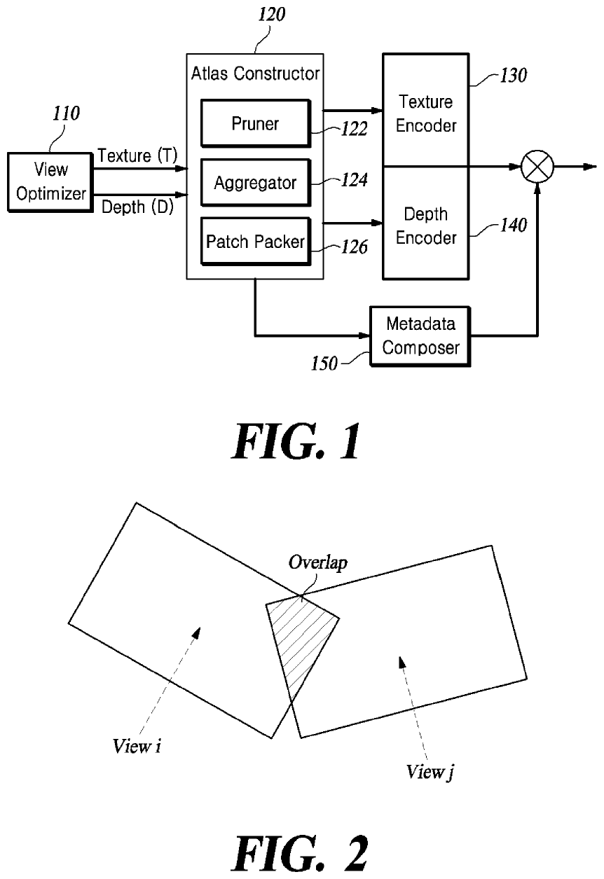

FIG. 1 is a block diagram illustrative of an immersive video encoding device capable of implementing the techniques of the present disclosure.

The software model for compression of multi-view point immersive video developed by MPEG-I is referred to as the Test model for MIV (TMIV). According to the example shown in FIG. 1, the input to a TMIV encoder, i.e., an immersive video encoding device (hereinafter ‘encoding device’), is encoded by using a view optimizer, an atlas constructor, a texture encoder, and a depth encoder, in that order. The encoding device uses multiple textures and geometry captured by the omnidirectional cameras to generate an atlas encoding format after removing spatial redundancy and thereby compresses immersive video by using fewer video codecs.

The atlas constructor in the encoding device generates an MIV format composed of atlas patches. The atlas patch video is compressed by the texture encoder and the depth encoder that is composed of a high efficiency video coding (HEVC) or versatile video coding (VVC) codec. The immersive video decoding device (hereinafter ‘decoding device’) reconstructs the basic view point and atlas in relation to the video texture and depth information. The decoding device may also generate a view port image based on the viewer's motion by using intermediate view point image synthesis. Since metadata is required as control information for these processes, metadata and bitstream structure are standardized.

Immersive video and MIV are used interchangeably hereinafter.

The following describes, with reference to FIG. 1, the immersive video encoding device and its components in detail.

The encoding device includes all or part of a view optimizer 110, an atlas constructor 120, a texture encoder 130, a depth encoder 140, and a metadata composer 150. The encoding device uses the view optimizer 110 and then the atlas constructor 120 to generate an MPEG Immersive Video (MIV) format from the input multi-view point video and then uses the texture encoder 130 and the depth encoder 140 to encode the MIV format of data.

The view optimizer 110 classifies all view points included in the inputted multi-view point video into basic views and additional views.

To perform such view point optimization, the view optimizer 110 calculates how many basic views are needed, and selects the number of basic views equal to the determined number of basic views. The view optimizer 110, as illustrated in FIG. 2, may determine the basic view and additional view by using the physical locations of the respective view points (e.g., the angular difference between the view points) and the overlapping between the view points. Thus, the view point that has the most common scenes across all view points may be selected as the basic view. After the basic views and the additional views are selected, the basic views are preserved and directly inputted to the encoder.

In another embodiment according to the present disclosure, the view optimizer 110 may first group all the view points by considering the view points of the camera and their usage, and then construct basic views and additional views for each group.

The atlas constructor 120 constructs an atlas from the basic view and the additional view. As described above, the basic views selected by the view optimizer 110 are included in the atlas as intact images. The atlas constructor 120 generates from the additional views patches that represent hardly predictable areas based on the basic views and then organizes the patches generated from multiple additional views into one atlas. To generate the atlas, the atlas constructor 120 includes a pruner 122, an aggregator 124, and a patch packer 126, as illustrated in FIG. 1.

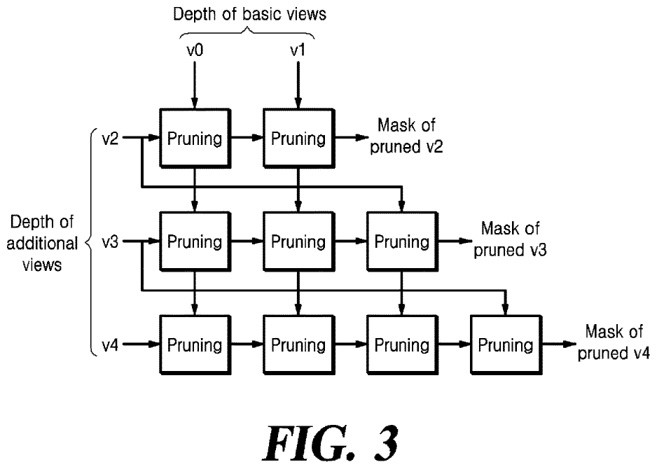

The pruner 122, as illustrated in FIG. 3, removes redundant portions of the additional views while preserving the basic views, but generates a binary mask indicating whether the pixels in the additional views are redundant or not. For example, the mask in one additional view has the same resolution as the additional view, with a value of ‘1’ indicating that the value at the relevant pixel in the depth image is valid, and a value of ‘0’ indicating that the pixel is redundant with the basic view and needs to be removed.

The pruner 122 searches for redundant information by warping in three-dimensional coordinates based on the depth information. Here, warping refers to the process of using depth information to estimate and compensate for displacement vectors between two view points.

The pruner 122, as illustrated in FIG. 3, also checks for redundancy with the additional view that has been pruned, and finally generates a mask. In the example of FIG. 3, for additional view v2, the pruner 122 generates a mask by checking for redundancy with reference views v0 and v1, and for additional view v3, the pruner 122 generates a mask by checking for redundancy with reference views v0 and v1 and additional view v2.

The aggregator 124 accumulates the masks generated for each additional view in temporal order. The accumulation of these masks may reduce the structural information of the final atlas.

The patch packer 126 packs the patches of the basic view and the additional view to finally generate the atlas. For the texture and depth information of the basic view, the patch packer 126 utilizes the original images as patches to construct the atlas of the basic view. For the texture and depth information of the additional view, the patch packer 126 utilizes masks to generate block patches and then packs the block patches to form the atlas of the additional view.

The texture encoder 130 encodes a texture atlas.

The depth encoder 140 encodes a depth atlas.

The texture encoder 130 and depth encoder 140 may be implemented by using conventional encoders, such as HEVC or VVC, as described above.

The metadata composer 150 generates sequence parameters related to the encoding, metadata for the multi-view camera, and atlas-related parameters.

The encoding device generates and transmits a bitstream obtained by combining the encoded texture, encoded depth, and metadata.

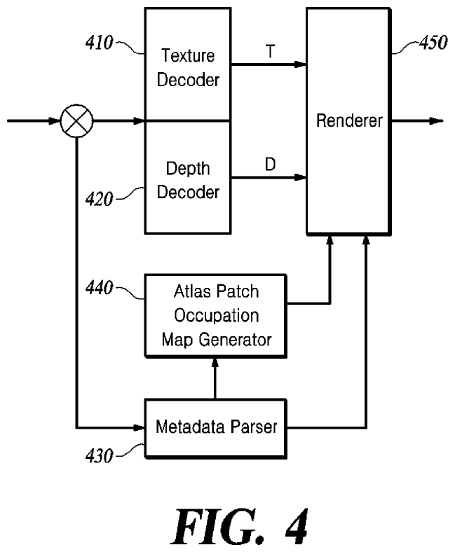

FIG. 4 is a block diagram of an immersive video decoding device capable of implementing the techniques of the present disclosure.

The immersive video decoding device (hereinafter referred to as ‘decoding device’) includes all or part of a texture decoder 410, a depth decoder 420, a metadata analyzer or parser 430, an atlas patch occupation map generator 440 (hereinafter referred to as ‘occupation map generator’), and a renderer 450.

The texture decoder 410 decodes the texture atlas from the bitstream.

The depth decoder 420 decodes a depth atlas from the bitstream.

The metadata parser 430 parses metadata from the bitstream.

The occupation map generator 440 generates an occupation map by using atlas-specific parameters contained in the metadata. The occupation map is information related to the locations of block patches, and the occupation map may be generated by the encoding device and transmitted to the decoding device or may be generated by the decoding device using the metadata.

The renderer 450 utilizes the texture atlas, the depth atlas, and the occupancy map to reconstruct the immersive video for presentation to the user.

As described above, encoding for the atlas may be performed by using a conventional encoder such as HEVC or VVC. In doing so, two modes may be applied.

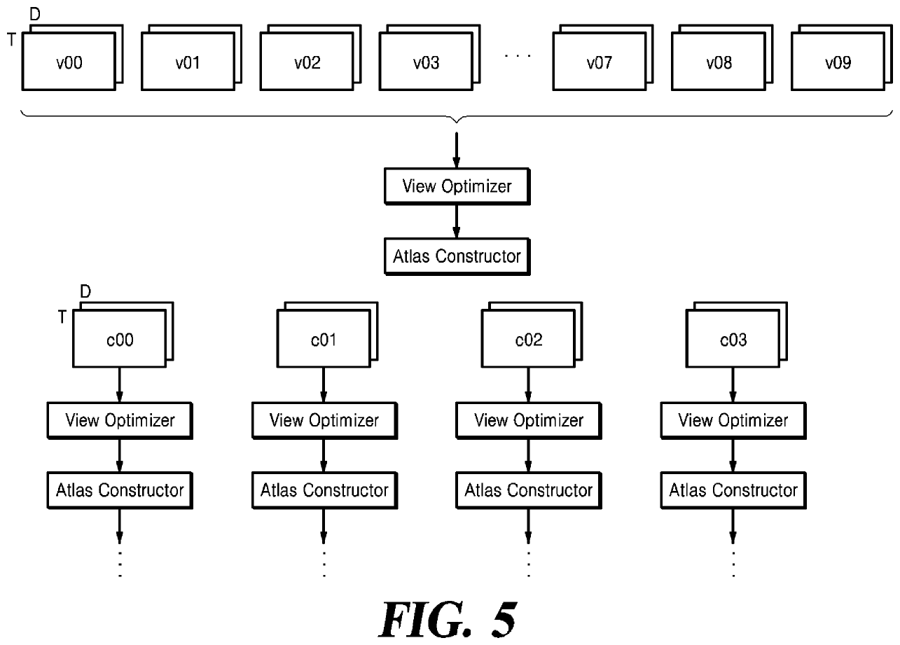

FIG. 5 is a block diagram illustrating an encoding scheme in MIV mode, according to at least one embodiment of the present disclosure.

In MIV mode, the encoding device compresses and transmits the video in its entirety. For example, as illustrated in FIG. 5, ten multi-view point videos are passed through the view optimizer 110 and the atlas constructor 120 in sequence, resulting in an atlas for one basic view and an atlas for three additional views. At this time, depending on the configuration of the multi-view point video, the encoding device may configure the number of basic views and additional views differently. The encoding device may encode each of the generated atlases by using a conventional encoder to generate a bitstream.

In another mode, the MIV view point mode, the encoding device transmits, for example, five view points out of a total of ten view points without generating an atlas. The decoding device synthesizes the remaining five intermediate view points by using the transmitted depth information and texture information.

An advantage of utilizing an atlas in terms of reducing the complexity of the decoding device is as follows. In the example of FIG. 5, when the encoding device utilizes a total of 20 encoders, including texture and depth, to transmit all 10 full view points, the decoding device also requires a total of 20 decoders, including texture and depth. On the other hand, when the encoding device generates an atlas for one basic view and three additional views, and then transmits the atlas by using a total of eight encoders, including texture and depth, the decoding device also needs a total of eight decoders, including texture and depth, which can significantly reduce the complexity.

Meanwhile, the TMIV encoder, i.e., the encoding device, utilizes a group encoder. The encoding device spatially groups the texture and geometric information obtained in the omnidirectional space and encodes the immersive video per group space. At this time, the atlas image generated for each group is video-encoded. The decoding device utilizes this concept of grouping to allow for partial decoding of bitstream by bitstream based on spatial grouping, resulting in faster decoding.

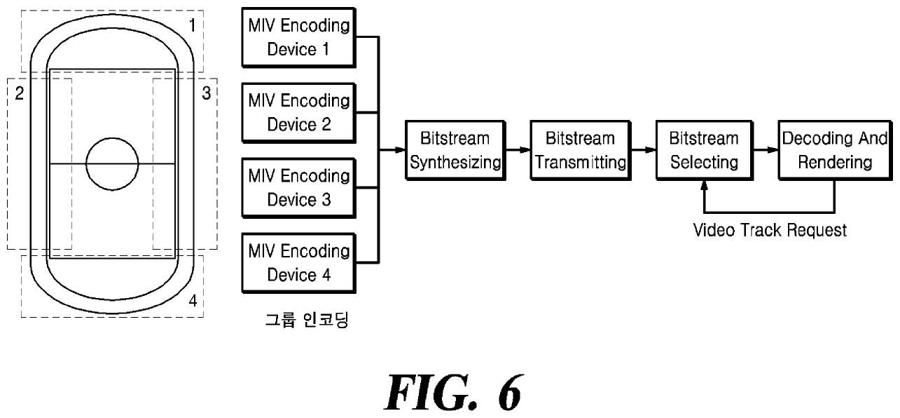

FIG. 6 is a diagram illustrating the concept of group encoding.

There are limitations to using a single encoding device to compress and transmit immersive video for all spaces and a single decoding device to decode all immersive videos for all spaces. Therefore, the encoding device transmits a multiplexed bitstream generated by dividing the space and encoding the immersive video for each space. The decoding device may extract the bitstream required for the view port image selected by the viewer, and then may decode the extracted bitstream to render the generated immersive video. In the example of FIG. 6, four spatially-specific encoding devices are utilized.

Hereinafter, the signaling of multi-view camera parameters will be described.

The view port represents the viewing area that the user is looking at within the entire omnidirectional video. For multi-view cameras arranged to capture space, the view port is typically represented by using camera explicit parameters and implicit parameters. In ISO/IEC 23090 Part 12, a MIV view parameter list containing camera extrinsic parameters and camera intrinsic parameters is defined as shown in Table 1, and the encoding device may signal the defined syntax to the decoding device.

```
TABLE 1
miv_view_params_list( ) {
  mvp_num_views_minus1
  mvp_explicit_view_id_flag
  if( mvp_explicit_view_id_flag ) {
    for( v = 0; v <= mvp_num_views_minus1; v++ ) {
      mvp_view_id[ v ]
      ViewIDToIndex[ mvp_view_id[ v ] ] = v
      ViewIndexToID[ v ] = mvp_view_id[ v ]
    }
  } else {
    for( v = 0; v <= mvp_num_views_minus1; v++ ) {
      ViewIDToIndex[ v ] = v
      ViewIndexToID[ v ] = v
    }
  }
  for( v = 0; v <= mvp_num_views_minus1; v++ ) {
    viewID = ViewIndexToID[ v ]
    camera_extrinsics( viewID )
    mvp_inpaint_flag[ viewID ]
  }
  mvp_intrinsic_params_equal_flag
  for( v = 0; v <= mvp_intrinsic_params_equal_flag ? 0 : mvp_num_views_min
us1; v++ ) {
    viewID = ViewIndexToID[ v ]
    camera_intrinsics( viewID, 0 )
  }
```

Here, mvp_um_views_minus1 represents ‘number of camera view points−1’. Thus, ‘mvp_num_views_minus1+1’ represents the number of camera view points. Alternatively, ‘mvp_num_views_minus1+1’ may represent the number of cameras corresponding to the view points.

The mvp_explicit_view_id_flag indicates whether mvp_view_id[v] is within the miv_view-params_list( ) syntax structure. For example, if mvp_explicit_view_id_flag is 1 and true, it indicates that mvp_view_id[v] is within the miv_view-params_list( ) syntax structure. Here, v indicates an index.

mvp_view_id[v] indicates the camera Identity (ID) corresponding to index v. The ID is a value from 0 to 65535. Here, the IDs of cameras with different indices are made to be different.

ViewIDToIndex and ViewIndexToID represent the conversion functions between the camera ID and the index.

The mvp_intrinsic_params_equal_flag indicates whether the intrinsic parameters of the camera with index 0 are the same as the intrinsic parameters of the rest of the cameras. For example, if mvp_intrinsic_params_equal_flag is true, the encoding device signals only the intrinsic parameters of the index 0 camera. On the other hand, if mvp_intrinsic_params_equal_flag is false, the encoding device signals the intrinsic parameters for all cameras.

Next, the camera extrinsic parameters are shown in Table 2.

TABLE 2

```
camera_extrinsics( viewID ) {
  ce_view_pos_x[ viewID ]
  ce_view_pos_y[ viewID ]
  ce_view_pos_z[ viewID ]
  ce_view_quat_x[ viewID ]
  ce_view_quat_y[ viewID ]
  ce_view_quat_z[ viewID ]
}
```

Here, ce_view_pos_x[viewID], ce_view_pos_y[viewID], and ce_view_pos_z[viewID] represent the x-axis position, y-axis position, and z-axis position of the camera having the viewID.

ce_view_quat_x[viewID], ce_view_quat_y[viewID], and ce_view_quat_z[viewID] represent the x-axis rotation, y-axis rotation, and z-axis rotation of the camera having the viewID.

Next, the camera intrinsic parameters are shown in Table 3.

```
TABLE 3
camera_intrinsics( viewID, mode ) {
  ci_cam_type[ viewID ]
  ci_projection_plane_width_minus1[ viewID ]
  ci_projection_plane_height_minus1[ viewID ]
```

| | |
|---|---|
| if( ci_cam_type[ viewID ] == 0 ) { | /* equirectangular */ |

```
    ci_erp_phi_min[ viewID ]
    ci_erp_phi_max[ viewID ]
    ci_erp_theta_min[ viewID ]
    ci_erp_theta_max[ viewID ]
```

| | |
|---|---|
| } else if( ci_cam_type[ viewID ] == 1 ) { | /* perspective */ |

```
    ci_perspective_focal_hor[ viewID ]
    ci_perspective_focal_ver[ viewID ]
    ci_perspective_principal_point_hor[ viewID ]
    ci_perspective_principal_point_ver[ viewID ]
```

| | |
|---|---|
| } else if( ci_cam_type[viewID] == 2 ) { | /* orthographic */ |

```
    ci_ortho_width[ viewID ]
    ci_ortho_height[ viewID ]
  }
}
```

ci_cam type[viewID] indicates the projection method of the camera with viewTD. ci_cam type[viewID]0 indicates the Equirectangular Projection (ERP) method, 1 indicates the perspective projection method, and 2 indicates the orthographic projection method.

ci_erp_phi_min[viewID] and ci_erp_phi_max[viewID], each being one of −180′ 180′ values, represent the range of angles in the longitude direction in the ERP method. In addition, ci_erp_tkheta_min[viewID] and ci_erp_theta_max[viewID], each being one of −90′ 90′ values, represent the range of angles in the latitude direction in the ERP method.

ci_perspective_focal_hor[viewID] and ci perspective_focal_ver[viewID] represent the camera's focal horizontal position and focal vertical position in the perspective projection method. In addition, ci perspective principal point_hor[viewID] and ci_perspective_principal_point_ver[viewID] represent the principal point position in the perspective projection method.

ci_ortho_width[viewID] and ci_ortho_height[viewID] represent the width and height in the orthographic projection method.

Meanwhile, the metaverse is a portmanteau of meta, meaning virtual and transcendent, and the universe, meaning the real world, and in a metaverse environment, the viewer of a video can experience a mixed reality where the virtual and real interact. Traditional metaverse video content relies on computer graphics, but by using live-action video from arbitrary real-world locations in addition to the virtual environment, viewers can experience a more natural sense of space and presence. In the virtual space, users can move freely in 6DOF to maximize the sense of presence.

To date, 6DoF immersive video has been obtained by using a fixed multi-view camera positioned in an omnidirectional space in a conventional broadcast studio production environment. However, in the future, immersive video may be obtained by using freely movable cameras, and immersive video may be viewed by using HMDs (head-mounted displays). In other words, in terms of extending the viewer's range of movement into virtual space beyond the traditional concept of virtual space, meta mobility may enable a vivid vicarious experience of being in the real world by using mobile cameras mounted on autonomous agents.

Embodiments disclose methods of grouping and updating camera parameters for MPEG immersive video. More specifically, in an encoding and decoding method for immersive video, provided are methods of efficiently grouping and updating multi-view camera parameters for MIVs captured at different times and locations according to an arbitrary arrangement of mobile multi-view cameras.

Before describing embodiments of the present disclosure, the cases for applying some embodiments will first be described.

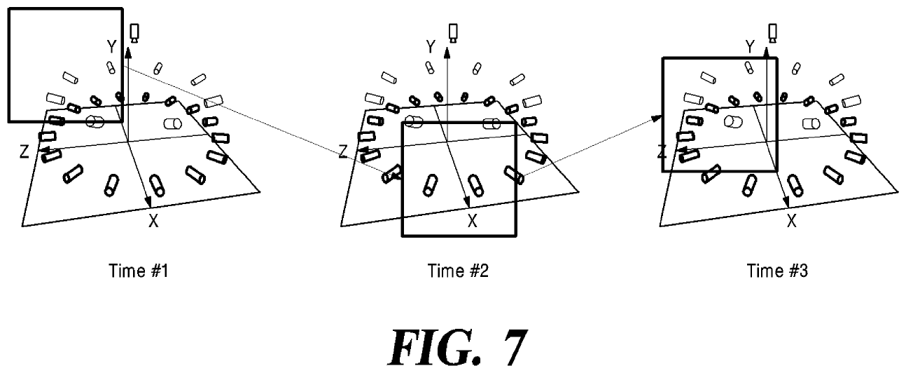

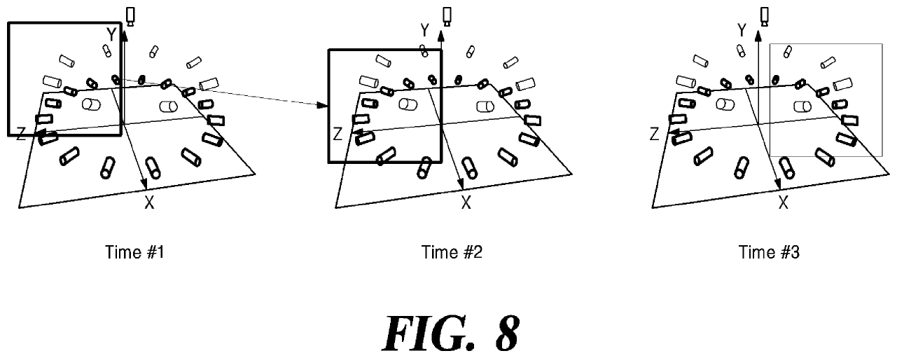

First, the present embodiment may be used where the position and arrangement of cameras change over time. In this embodiment, instead of capturing video with a fixed multi-view camera array on a fixed stage, an autonomous mobile swarm of intelligent entities, such as autonomous vehicles, robots, and the like, may utilize cameras to capture objects and scenes. Further, a user view port is extracted from the omnidirectional video. For example, in the figures of FIG. 7, the boxes indicate when the camera array changes over time.

This embodiment may be used where the position and arrangement of the cameras change as the view point space and scene captured by the cameras change. This embodiment may be applied where, instead of one video composed of footage captured by a fixed multi-view camera array on a fixed stage, the user moves the view point to any space to watch a different scene during the viewing time based on user interaction. This embodiment may be used to extract view ports for one or more groups of multi-view point videos pre-positioned in multiple spaces. For example, in the figures of FIG. 7, the bold boxes represent a case where the camera arrangement changes partially from space to space, and the thin box on the right represents a case where the camera arrangement changes with entirely new camera IDs.

In addition, this embodiment may be used where video is captured by different types of omnidirectional video sensors configured per scene. This embodiment may be used for view port extraction when a user moves from view point to view point interacting with multiple random spaces rather than a fixed environment during a viewing time. Instead of an omnidirectional video with a fixed resolution and a fixed format for a single scene, the present embodiment may utilize a group of videos generated by sensors that may secure different ranges of field of view (FoV) or obtain different kinds of spatial information. In addition to traditional perspective 2D video, the present embodiment may organize video groups in various formats, acquired by 360° video, lidar sensors, depth video, and the like, may group the camera parameters together and may transmit the grouped camera parameters.

### <Implementation 1> Grouping and Transmitting Camera Parameters According to Scene and Time

In one example according to this implementation, to render video captured in a single space at a high speed, the encoding device stores camera parameters grouped by scene and transmits the grouped parameters. The decoding device decodes the grouped parameters and uses the decoded parameters to extract a view port. For example, in addition to transmitting camera extrinsic parameters per viewID, the encoding device may also organize and transmit camera extrinsic parameters differently per space or scene. The decoding device may be responsive to when spaces and scenes are switched based on user input for using the space- or scene-specific camera extrinsic parameters to quickly extract view ports in the relevant space.

As shown in Table 4, the camera extrinsic syntax used by the MIV standard, ISO/IEC 23090 Part 12, may be grouped and signaled by scene. Similarly, camera intrinsic syntax may also be grouped and managed by scene.

TABLE 4

```
camera_extrinsics( viewID , sceneID) {
  ce_view_pos_x[ viewID ][sceneID]
  ce_view_pos_y[ viewID ] [sceneID]
  ce_view_pos_z[ viewID ] [sceneID]
  ce_view_quat_x[ viewID ] [sceneID]
  ce_view_quat_y[ viewID ] [sceneID]
  ce_view_quat_z[ viewID ] [sceneID]
}
```

Additionally, a list of MIV view parameters may also be signaled, grouped by scene, as shown in Table 5.

TABLE 5

```
for( v = 0; v <= mvp_num_views_minus1; v++ ) {
  for( s = 0; s <= mvp_num_scenes_minus1; s++ ) {
    viewID = ViewIndexToID[ v ][ s ]
    camera_extrinsics( viewID , s)
    ...
  }
}
```

The MIV view parameter list includes a parameter representing the number of scenes constituting the video, i.e., the number of spaces holding different groups of multi-view point videos. For example, in Table 5, mvp_num_scenes_minus1 is a parameter representing the number of spaces in which different groups of multi-view point videos are obtained. Furthermore, s is an index representing a scene, and sceneID, an ID for the scene exemplified in Table 4, may be derived from s.

As described above, since the scenes are grouped, the decoding device may decode a scene more quickly when reconstructing a scene.

On the other hand, if the number of scenes is one, the multi-view point video constitutes one group. In such a case, the encoding device may not signal the number of scenes, and the decoding device may infer that the number of scenes is 1. In other words, this implementation may encompass a fixed multi-view camera array capturing video on a fixed stage.

As another example, to reflect varying camera positions per time, the encoding device stores separate camera parameters provided with time indices and transmits parameters grouped according to the time indices. The decoding device decodes the grouped parameters and uses the decoded parameters to extract the view port. For example, in addition to transmitting camera extrinsic parameters per viewID, the encoding device organizes and transmits different camera extrinsic parameters per time. The decoding device may be responsive to when the time and thus the camera arrangement space and scene are changed based on user input for utilizing the time-specific camera extrinsic parameters to quickly extract view ports in a given space.

For example, as shown in Table 6, the camera extrinsic syntax used by the MIV standard ISO/IEC 23090 Part 12 may be dynamically grouped and signaled per time. Similarly, camera intrinsic syntax may be dynamically grouped and managed per time.

TABLE 6

```
camera_extrinsics( viewID , timeID) {
  ce_view_pos_x[ viewID ][ timeID]
  ce_view_pos_y[ viewID ] [timeID]
  ce_view_pos_z[ viewID ] [timeID]
  ce_view_quat_x[ viewID ] [timeID]
  ce_view_quat_y[ viewID ] [timeID]
  ce_view_quat_z[ viewID ] [timeID]
}
```

Additionally, a list of MIV view parameters may also be grouped and signaled per time, as shown in Table 7.

TABLE 7

```
for( v = 0; v <= mvp_num_views_minus1; v++ ) {
  for( t = 0; t <= mvp_num_time_minus1; t++ ) {
    viewID = ViewIndexToID[ v ][ t ]
    camera_extrinsics( viewID , t)
    ...
  }
}
```

The MIV view parameter list includes a parameter representing the number of time intervals (time steps) at which the configuration of the video changes, i.e., the number of time steps that constitute different groups of multi-view point videos. For example, in Table 7, mvp_num_time_minus1 is a parameter representing a change in which a group of multi-view point videos is arranged according to time steps. Further, t is an index representing a time step, and timeID, an ID for a time step exemplified in Table 6, may be derived from t.

As described above, since the time steps are grouped into one group, the decoding device may decode the multi-view point video corresponding to one time step more quickly when reconstructing the multi-view point video.

On the other hand, if the number of time steps is one, the multi-view point videos constitute one group. In such a case, the encoding device does not signal the number of time steps, and the decoding device may infer that the number of time steps is 1. In other words, this implementation may encompass organizing the videos captured by a fixed multi-view camera array on a fixed stage into a single video.

<Implementation 2> Constructing an Omnidirectional Video with Different Formats Per Scene and Grouping and Transmitting Camera Parameters

In this implementation, to provide a high degree of viewing freedom based on rich three-dimensional spatial information according to a user view point in an arbitrary scene during a watching time, the encoding device obtains immersive videos having different formats for one scene. Then, the encoding device groups and stores multi-view camera parameters according to each format and transmits the grouped parameters. The decoding device decodes the grouped parameters and uses the decoded parameters to extract the view port. Since the same three-dimensional environment is reconstructed in different video formats and view points, the encoding device transmits a scene in various formats in terms of view point and time, and the decoding device may use these various formats to extract spatially free view ports.

For example, there are a multi-view point video format captured from a sensor with limited FoV at each view point but low distortion and a multi-view point 360-degree video captured with a 360-degree virtual reality (VR) camera that captures omnidirectional spatial information at each view point but involves distortions depending on the view point angle, and the present disclosure can use these video formats complementarily. In other words, the view port may be reproduced with minimal occlusion and distortion based on the spatial information at the view point. In addition to this, the present disclosure can use point cloud data and depth information, too. In MIV, the encoding device may encode different kinds of data such as 360-degree multi-view point video, point cloud, depth information, and the like in addition to the regular multi-view point video. The decoding device may render these different data complementarily.

Meanwhile, camera extrinsic syntax used by the MIV standard ISO/IEC 23090 Part 12 may be signaled, grouped by sensor, as shown in Table 8. Similarly, camera intrinsic syntax may also be grouped and managed by a sensor.

TABLE 8

```
camera_extrinsics( viewID , sensorID) {
  ce_view_pos_x[ viewID ][ sensorID]
  ce_view_pos_y[ viewID ] [sensorID]
  ce_view_pos_z[ viewID ] [sensorID]
  ce_view_quat_x[ viewID ] [sensorID]
  ce_view_quat_y[ viewID ] [sensorID]
  ce_view_quat_z[ viewID ] [sensorID]
}
```

Additionally, a list of MIV view parameters may also be signaled, grouped by sensor, as shown in Table 9.

TABLE 9

```
for( v = 0; v <= mvp_num_views_minus1; v++ ) {
  for( s = 0; s <= mvp_num_sensor_minus1; s++ ) {
    viewID = ViewIndexToID[ v ][ s ]
    camera_extrinsics( viewID , s)
    ...
  }
}
```

The MIV view parameter list includes a parameter representing the number of sensors that form the video, i.e., the number of sensors used to generate different groups of multi-view point videos. For example, in Table 9, mvp_num_sensor_minus1 is a parameter representing the number of sensors used to obtain different groups of videos. Further, s is an index representing a sensor, and sensorID, which is an ID for the sensor exemplified in Table 8, may be derived from s.

As described above, since the sensors are grouped into one group, the decoding device may decode the multi-view point video corresponding to one sensor more quickly when reconstructing the multi-view point video.

On the other hand, if the number of sensors is one, the multi-view point videos constitute one group. In such a case, the encoding device may not signal the number of sensors, and the decoding device may infer that the number of sensors is 1. In other words, this implementation may encompass organizing the omnidirectional video in a fixed resolution and a fixed format for a single scene.

In addition to transmitting the aforementioned camera parameters in a video sequence, the camera parameters may also be transmitted in headers of Intra Random Access Pictures (IRAP) video frames, video pictures, or slices. In this case, the encoding device may determine all scene-specific, time-specific, and sensor-specific camera parameters and signal the determined parameters. Further, if a user view point is moved, or if a multi-view point video is rearranged and a new group video is required, the corresponding camera parameters may be updated and transmitted. After decoding the scene-specific, time-specific, and sensor-specific camera parameters, the decoding device may extract the view port by using the camera parameters appropriate for the scene, time, or sensor.

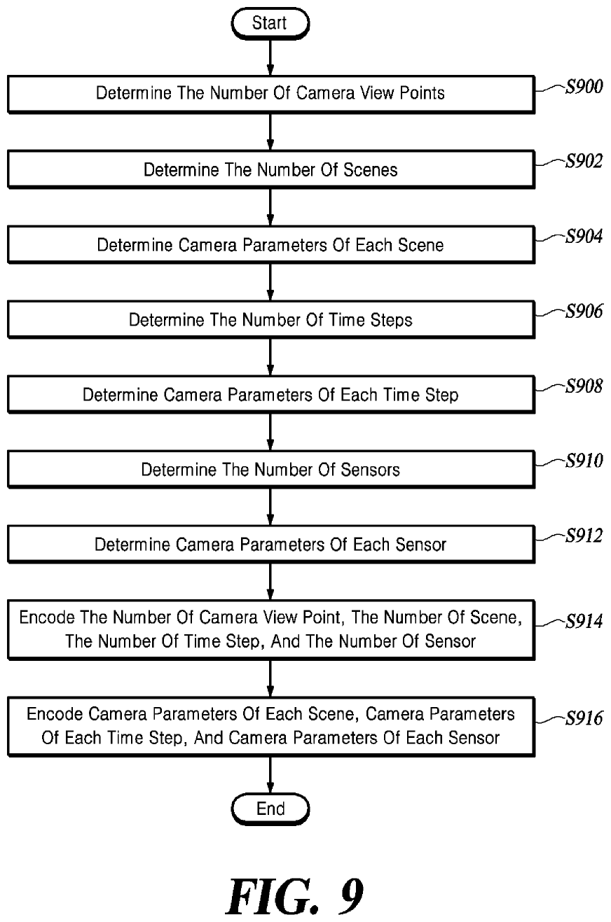

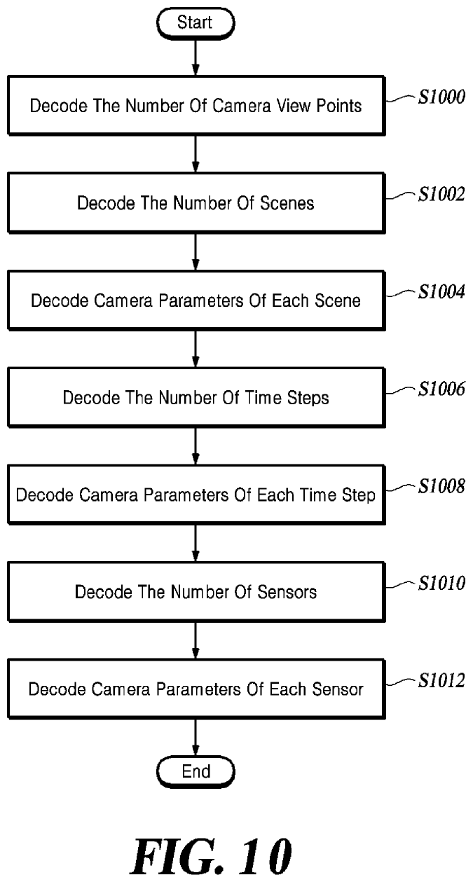

Referring now to the figures of FIGS. 9 and 10, methods for encoding and decoding camera parameters for immersive video are described.

FIG. 9 is a flowchart of a method performed by an immersive video encoding device for encoding camera parameters, according to at least one embodiment of the present disclosure.

The encoding device determines the number of camera view points (S900). The multi-view point video may be captured from the camera view points. The number of camera view points may indicate the number of cameras utilized to capture the multi-view point video.

The encoding device determines the number of scenes (S902). Here, the number of scenes indicates the number of spaces holding the different groups of multi-view point videos.

The encoding device determines camera parameters for each scene based on the number of camera view points and the number of scenes (S904).

Here, the camera parameters include camera explicit parameters and camera implicit parameters. The camera explicit parameters include the camera position corresponding to each camera view point and each scene, and the rotating direction of the camera. Further, the camera implicit parameters include camera's projection method corresponding to each camera view point and each scene, and parameter values representing the projection method.

The encoding device determines the number of time steps (S906). Here, different groups of multi-view point videos may be configured according to the number of time steps.

Based on the number of camera view points and the number of time steps, the encoding device determines camera parameters for each time step (S908).

At this time, the camera explicit parameters include the camera position corresponding to each camera view point and each time step, and a rotating direction of the camera. Further, the camera implicit parameters include the camera's projection method corresponding to each camera view point and each time step, and parameter values representing the projection method.

The encoding device determines the number of sensors (S910). Here, different groups of multi-view point videos may be configured based on the number of sensors. Further, each sensor may capture a multi-view point video, a 360-degree video, a point cloud, or depth information.

The encoding device determines camera parameters for each sensor based on the number of camera view points and the number of sensors (S912).

At this time, the camera explicit parameters include the camera position corresponding to each camera view point and each sensor, and the rotating direction of the camera. Further, the camera implicit parameters include a projection method of the camera corresponding to each camera view point and each sensor, and parameter values representing the projection method.

The encoding device encodes the number of camera view points, the number of scenes, the number of time steps, and the number of sensors (S914).

The encoding device encodes the camera parameters of each scene, the camera parameters of each time step, and the camera parameters of each sensor (S916).

The encoding device may update the corresponding camera parameters when a user view point is moved, or when multi-view point videos are rearranged and a new group video is required.

FIG. 10 is a flowchart of a method performed by an immersive video decoding device for decoding camera parameters, according to at least one embodiment of the present disclosure.

The decoding device decodes the number of camera view points from a bitstream (S1000). A multi-view point video may be obtained from the camera view points. The number of camera view points may indicate the number of cameras utilized to capture the multi-view point video.

The decoding device decodes the number of scenes from the bitstream (S1002). Here, the number of scenes indicates the number of spaces holding different groups of multi-view point videos.

The decoding device decodes, from the bitstream, camera parameters for each scene based on the number of camera view points and the number of scenes (S1004).

Here, the camera parameters include camera explicit parameters and camera implicit parameters. The camera explicit parameters include the camera position corresponding to each camera view point and each scene, and the rotating direction of the camera. Further, the camera implicit parameters include a projection method of the camera for each camera view point and each scene, and parameter values representing the projection method.

The decoding device decodes the number of time steps from the bitstream (S1006). Here, different groups of multi-view point videos may be configured based on the number of time steps.

Based on the number of camera view points and the number of time steps, the decoding device decodes the camera parameters for each time step from the bitstream (S1008).

The camera explicit parameters include the camera position corresponding to each camera view point and each time step, and the rotating direction of the camera. Further, the camera implicit parameters include a projection method of the camera corresponding to each camera view point and each time step, and parameter values representing the projection method.

The decoding device decodes the number of sensors from the bitstream (S1010). Here, different groups of multi-view point videos may be configured based on the number of sensors. Further, each sensor corresponds to a multi-view point video, a 360-degree video, a point cloud, or depth information.

The decoding device decodes, from the bitstream, the camera parameters of each sensor based on the number of camera view points and the number of sensors (S1012).

The camera explicit parameters include the camera position corresponding to each camera view point and each sensor, and a rotating direction of the camera. Further, the camera implicit parameters include a projection method of the camera corresponding to each camera view point and each sensor, and parameter values representing the projection method.

The decoding device may then extract a view port for the user by using the camera parameters appropriate for each scene, each time step, or each sensor.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

110: view optimizer
120: atlas constructor
130: texture encoder
140: depth encoder
150: metadata composer
410: texture decoder
450: depth decoder
430: metadata parser
440: atlas patch occupation map generator
450: renderer

### CROSS-REFERENCE TO RELATED APPLICATIONS

This application claims priority to and the benefit of Korean Patent Application No. 10-2022-0056664 filed on May 9, 2022, and Korean Patent Application No. 10-2023-0044499, filed on Apr. 4, 2023, the entire contents of each of which are incorporated herein by reference.

1. A method of decoding an immersive video, performed by an immersive video decoding device, the method comprising:
decoding from a bitstream a number of camera view points;
decoding from the bitstream a number of scenes that represents a number of spaces occupied by different groups of multi-view point videos; and
decoding, from the bitstream, camera parameters of each of the scenes based on the number of camera view points and the number of scenes,
wherein the camera parameters comprise:
camera explicit parameters and camera implicit parameters.

2. The method of claim 1, further comprising:
decoding from the bitstream a number of time steps, which is used as a basis for constructing the different groups of the multi-view point videos; and
decoding, from the bitstream, camera parameters of each of the time steps based on the number of camera view points and the number of time steps.

3. The method of claim 1, further comprising:
decoding from the bitstream a number of sensors, which is used as a basis for constructing the different groups of the multi-view point videos; and
decoding, from the bitstream, camera parameters of each of the sensors based on the number of camera view points and the number of sensors.

4. The method of claim 1, wherein the camera explicit parameters comprise:
a position of a camera corresponding to each of the camera view points and each of the scenes, and a rotating direction of the camera.

5. The method of claim 1, wherein the camera implicit parameters comprises:
a projection method of a camera corresponding to each of the camera view points and each of the scenes, and parameter values representing the projection method.

6. The method of claim 2, wherein the camera explicit parameters comprise:
a position of a camera corresponding to each of the camera view points and each of the time steps, and a rotating direction of the camera.

7. The method of claim 2, wherein the camera implicit parameters comprise:
a projection method of a camera corresponding to each of the camera view points and each of the time steps, and parameter values representing the projection method.

8. The method of claim 3, wherein the camera explicit parameters comprise:
a position of a camera corresponding to each of the camera view points and each of the sensors, and a rotating direction of the camera.

9. The method of claim 3, wherein the camera implicit parameters comprise:
a projection method of a camera corresponding to each of the camera view points and each of the sensors, and parameter values representing the projection method.

10. The method of claim 3, further comprising:
extracting a view port by using camera parameters appropriate for each of the scenes, each of the time steps, or each of the sensors.

11. The method of claim 3, wherein each of the sensors operates responsive to the multi-view point videos, 360-degree videos, point clouds, or depth information.

12. A method of encoding an immersive video, performed by an immersive video encoding device, the method comprising:
determining a number of camera view points;
determining a number of scenes that represents a number of spaces occupied by different groups of multi-view point videos; and
determining camera parameters of each of the scenes based on the number of camera view points and the number of scenes,
wherein the camera parameters comprise:
camera explicit parameters and camera implicit parameters.

13. The method of claim 12, further comprising:
determining a number of time steps, which is used as a basis for constructing the different groups of the multi-view point videos; and
determining camera parameters of each of the time steps based on the number of camera view points and the number of time steps.

14. The method of claim 13, further comprising:
determining a number of sensors, which is used as a basis for constructing the different groups of the multi-view point videos; and
determining camera parameters of each of the sensors based on the number of camera view points and the number of sensors.

15. The video encoding method of claim 14, further comprising:
encoding the number of camera view points, the number of scenes, the number of time steps, and the number of sensors.

16. The video encoding method of claim 14, further comprising:
encoding the camera parameters of each of the scenes, the camera parameters of each of the time steps, and the camera parameters of each of the sensors.

17. The video encoding method of claim 16, wherein encoding the camera parameters comprises:
responsive to when a user view point is moved or when a multi-view point video is rearranged to require a new group video, updating the camera parameters that are relevant.

18. A computer-readable recording medium storing a bitstream generated by an immersive video encoding method, the immersive video encoding method comprising:
determining a number of camera view points;
determining a number of scenes that represents a number of spaces occupied by different groups of multi-view point videos; and
determining camera parameters of each of the scenes based on the number of camera view points and the number of scenes,
wherein the camera parameters comprise:
camera explicit parameters and camera implicit parameters.
